(19) United States
(12) Patent Application Publication
(10) Pub. No.: US 2010/0319941 A1
(43) Pub. Date: Dec. 23, 2010

(54) Trenching Device And System

(75) Inventor: John Peterson, Jackson, MN (US)

Correspondence Address: Merchant & Gould AGCO, P.O. Box 2903, Minneapolis, MN, 55402, US

(73) Assignee: AGCO Corp., Duluth, GA (US)

(21) Appl. No.: 12/489,261

(22) Filed: Jun. 22, 2009

(51) Int. Cl. A01B 79/00; A01B 33/16; A01B 63/111

(52) U.S. Cl. 172/1; 172/76; 172/239

(57) ABSTRACT

A device for trenching and a system of controlling trenching at a constant depth and at a speed of more than 12 miles per hour.

### FIELD OF THE INVENTION

The present invention relates to agricultural implements used for in soil banding of fertilizer or seeds.

### BACKGROUND OF THE INVENTION

Modern agriculture requires large amounts of fertilizer to be spread over high acreage fields in the quickest, most efficient manner. Two methods are used to spread fertilizer: broadcast and in soil banding.

In soil banding has several advantages. First, in soil banding is often the preferred method because it targets fertilizer near the seed and unlike broadcast fertilizer, in soil banding does not waste fertilizer by placing it away from the seed and in spots where it can fertilize weeds instead of crops. Second, in soil banding can be used in reduced-till or no-till systems. Third, when in soil banding is used instead of tilling, there is reduced soil erosion, better moisture conservation, reduced weed growth, reduced operating cost, and better seed germination and crop establishment.

In soil banding can be accomplished by opening the soil with openers such as discs, knives, sweeps, double discs and single angle discs. The disc or blade is attached to a frame which is pulled behind a tractor to make a furrow in the soil where application material such as fertilizer or seeds can be placed.

In soil banding relies on downward pressure on the disc or blade to achieve a band depth in the soil surface. Pressure is commonly applied to the disc or blade by a single spring or a hydraulic cylinder. This method of in soil banding limits the ground speed of the agricultural machine to less than 10 miles per hour because sufficient time is needed to enable the spring or hydraulic cylinder to adjust to the soil conditions such as uneven terrain, varying soil density, and friction between the disc or blade and the soil. While in soil banding has the advantage over broadcast methods because in soil banding is a targeted approach, broadcast methods are quicker to apply to the soil without dynamic repositioning in real time. The problem is to compete with broadcast methods, equipment using trenching methods need to travel much faster (speeds greater that 12 mph) than equipment currently does and still maintain a precise placement of product at the desired depth.

What is needed therefore is a closed loop depth control system that utilizes in soil banding techniques, yet can deliver constant band depths at speeds greater than 12 mph. It is to such a device and system that the present invention is primarily directed.

### SUMMARY OF THE INVENTION

Briefly described, in preferred form, the present invention is a device for trenching and a system of controlling trenching at a constant depth and at a speed of more than 12 miles per hour. The control system to be used on such a furrow opener can include a height sensing assembly along the main frame of the banding device to determine the absolute implement-to-ground dimension at each row location, a depth sensing assembly to determine the furrow depth in the soil, an actuator or cylinder to apply a varying load to the row unit, a processor to provide a real-time calculation of the dimension requirements, a pressure regulator/driver to control the length of the actuator or cylinder, and a soil condition sensing assembly.

These and other objects, features, and advantages of the present invention will become more apparent upon reading the following specification in conjunction with the accompanying drawings.

### BRIEF DESCRIPTION OF THE DRAWINGS

FIG. 1 is a side view of farm equipment with a closed loop depth control device for trenching soil according to a preferred embodiment of the present invention.

FIG. 2 is a top view of an implement with a closed loop depth control device for trenching soil according to a preferred embodiment of the present invention.

FIG. 3 is a top view of a closed loop depth control device for trenching soil according to a preferred embodiment of the present invention.

FIG. 4 is a side, close-up view of an individual unit of a closed loop depth control device for trenching soil according to a preferred embodiment of the present invention.

FIG. 5 is a top view of a farm implement with a closed loop depth control device for trenching soil according to another embodiment of the present invention.

FIG. 6 is flow chart describing the control system of a closed loop depth control device for trenching soil.

### DETAILED DESCRIPTION

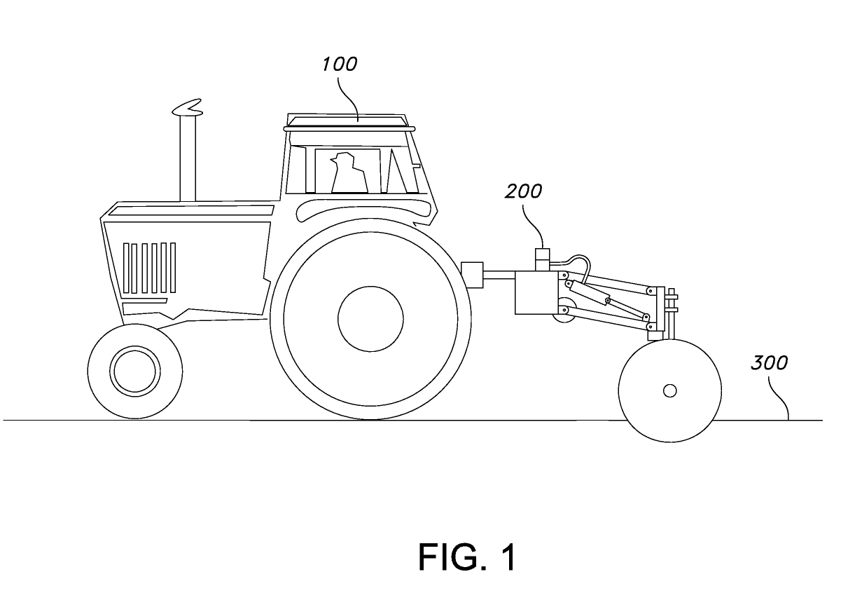

While the invention is susceptible to various modifications and alternative forms, a specific embodiment thereof has been shown by way of example in the drawings and will herein be described in detail. It should be understood, however, that there is no intent to limit the invention to the particular form disclosed, but on the contrary, the intention is to cover all modifications, equivalents, and alternatives falling within the spirit and scope of the invention as defined by the appended claims. Exemplary embodiments of the present invention are shown in the FIGS. 1-5.

FIG. 1 shows a tractor 100 pulling a closed loop depth control device 200 across the soil 300. The closed loop depth control device for trenching soil 200 maintains a near constant depth of +/−10% as it is being pulled behind the tractor 100. A near constant depth is very important because it allows for the precise placement of application material 400 at the proper depth in the furrow. A closed loop depth control device 200 uses a furrow opening assembly 500 controlled on each row unit 600 by an automated adjustment system 700 to maintain a near constant depth into the soil 300 when traversing the soil 300 at speeds of 12 miles per hour or greater.

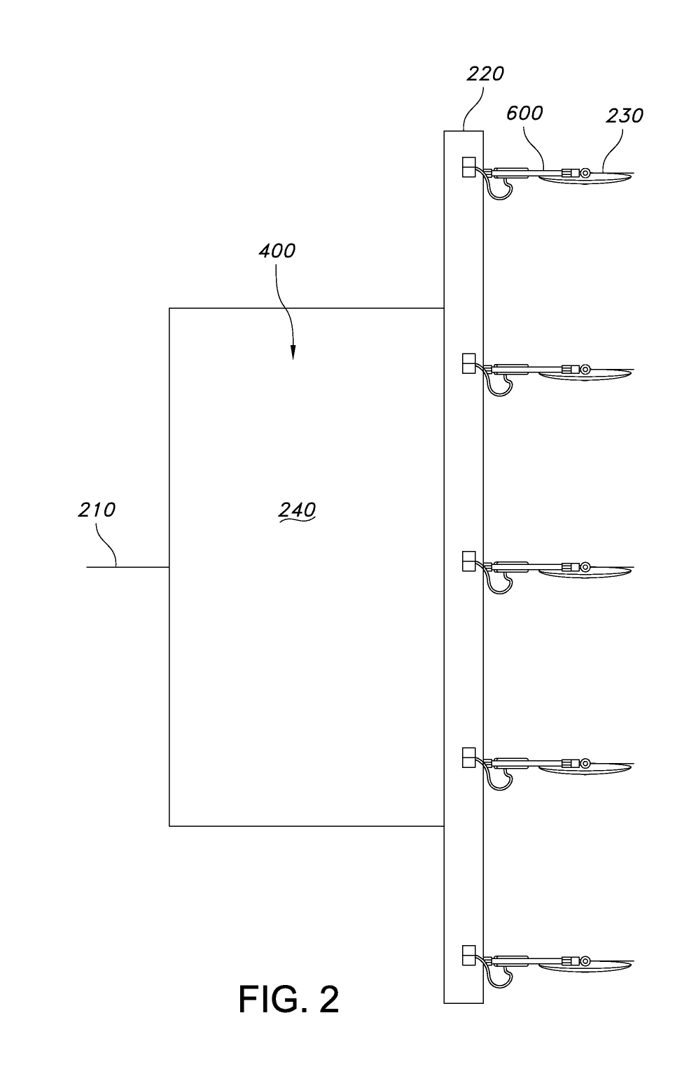

FIG. 2 shows a closed loop depth control device 200 that has a horizontal member 210 used to attach a frame 220 to a tractor 100. Optionally attached to the frame 220 is an application device 230 such as a tube or chute that connects on one end to a container 240 of application material 400 and on the other end, the application device 230 is connected to the furrow opening assembly 500. The application material 400 exits the application device 230 behind the furrow opening assembly 500.

The soil 300 that is opened by the furrow opening assembly 500 has a variety of densities. For instance, the soil 300 could be very sandy and easy to open with the furrow opening assembly 500. Or the soil 300 could be very thick like clay which makes it very difficult to open with the furrow opening assembly 500. The furrow opening assembly 500 would also have difficulty opening hard soil 300 that is densely packed together or rocky soil that has a lot of unevenness and rocks.

The soil level is uneven. The soil level itself has often has hills and valleys like the terrain in general. Vegetation left behind from prior plantings can also cause peaks in the soil 300. Very rarely will the soil level be perfectly flat.

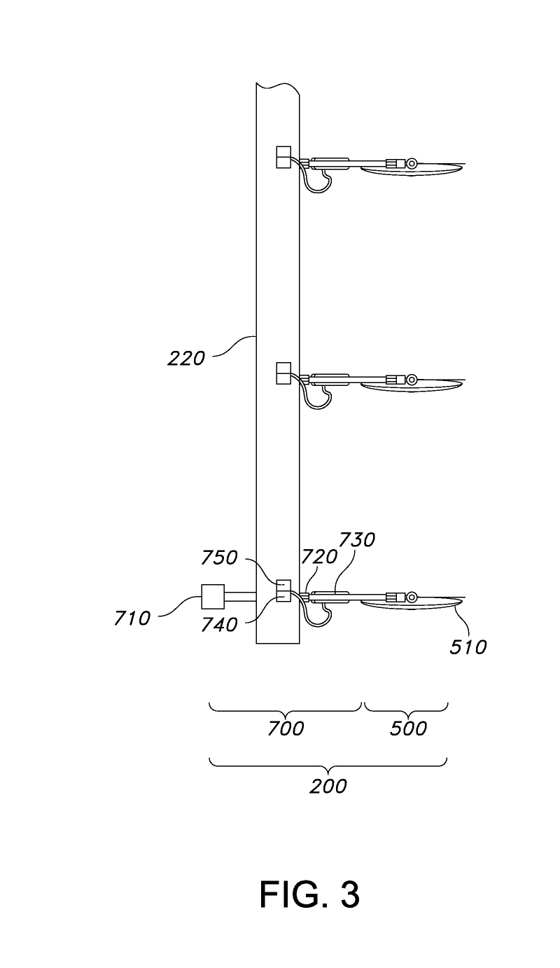

In order to maintain near constant depth, the closed loop depth control device 200 uses an automated adjustment system 700 can dynamically adjust the force the furrow opening assembly 500 applies to the soil 300 to provide the near constant depth into the soil 300, as the soil 300 varies in densities and level. FIG. 3 shows a closer top view of a closed loop depth control device 200 with a plurality of row units 600 attached to a frame 220, which is a straight member made of a durable material connecting a plurality of row units 600 in a straight line. Each row unit 600 has an automated adjustment system 700 and a furrow opening assembly 500. The furrow opening assembly 500 contains a furrow opener 510. A furrow opener 510 can include as discs, knives, sweeps, double discs and single angle discs for use to open the soil. In the present embodiment, the furrow opener 510 is a disc. An automated adjustment system 700 can be used to adjust the downward force on the furrow opening assembly 500 to control the depth that the furrow opener 510 will cut into the soil. An automated adjustment system 700 can include six basic functional blocks for each row unit 600: a height sensing assembly 710; a depth sensing assembly 720; an actuator 730; an actuator control 740; a processor 750; and a soil condition sensing assembly 760.

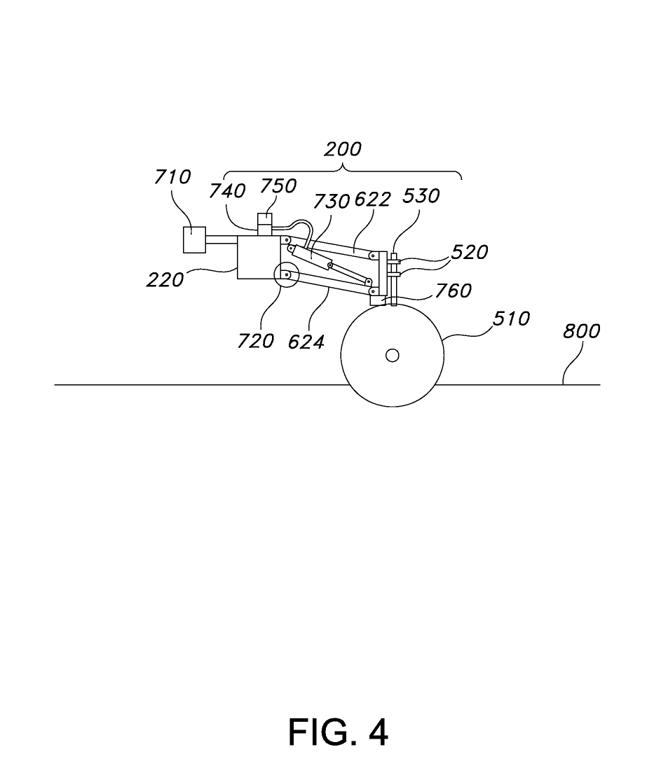

FIG. 4 shows a detailed drawing of both an automated adjustment system 700 and the furrow opening assembly 500. The furrow opening assembly 500 can be attached to the frame 220 by an arm 610. The arm 610 includes an actuator 730 and two stabilizing members 622, 624. One stabilizing member 622 can be above the actuator 730 and one stabilizing member 624 is below the actuator 730. The stabilizing members 622, 624 can be connected to the right face of frame 220 on end and can be connected on the other end to the furrow opening assembly 500, which can include furrow handle 520 extending horizontal from the arm 610 and attached on the top end of the vertical member 530 that has the furrow opener 510 at the other end. A furrow opening system 500 is connected to an automated adjustment system 700 by the arm 610, which includes the stabilizing members 620 that are generally horizontal and attached can move up and down relative to the soil 300.

An automated adjustment system 700 can be used to adjust the downward force on the furrow opener 510 to control the depth that the furrow opener 510 will cut into the soil 300. An automated adjustment system 700 can include six basic functional blocks for each row unit 600: a height sensing assembly 710; a depth sensing assembly 720; an actuator 730; a processor 740; an actuator control 750; and a soil condition sensing assembly 760.

The actuator 730 can be mounted to the furrow opening assembly 500 on one end and the frame 220 on one end. The actuator 730 is a mechanical device used to exert downward force on the furrow opening assembly 500. Some examples of actuators 730 include but are not limited to a spring, a pneumatic or hydraulic cylinder, or other force-driven device such as a motor. The actuator control 750 can be mounted on top of the frame 220 or on top of the actuator 730. The actuator control 740 controls how much downward force the actuator 730 will exert on the furrow opening assembly 500. The actuator control 740 receives its instructions from a processor 750.

The processor 750 can be attached above the actuator control 740, on the frame 220, or any location within close enough proximity to the actuator control 740, the height sensing assembly 710, the depth sensing assembly 720, and the soil condition sensing assembly 760 to use a hard wire. The processor 750 can also use a wireless connection to communicate with the actuator control 740, the height sensing assembly 710, the depth sensing assembly 720, and the soil condition sensing assembly 760. The processor 750 can use the output from the height sensing assembly 710 and soil condition sensing assembly 760 to calculate the proper fertilizer depth and compare it with the output of the depth sensing assembly 720. If the proper depth is not being maintained, the processor 750 will send information to the actuator control 740 to adjust the down force exerted by the actuator 730. The processor 750 can also query the height sensing assembly 710, depth sensing assembly 720, and soil condition sensing assembly 760.

The height sensing assembly 710, the depth sensing assembly 720, and the soil condition sensing assembly 760 can have specialized jobs. A height sensing assembly 710 can be used to determine the height of the frame 220 from the soil 300. The depth sensing assembly 720 can be used to determine how deep a furrow the furrow opener 510 would be making in the soil. The output of the depth sensing assembly 720 can be sent into a processor 750. A soil condition sensing assembly 760 can supply information regarding the effect of current ground speed and soil density, or compaction, on the row unit 600.

The height sensing assembly 710 can be attached to left face of the frame 220. The depth sensing assembly 720 can be attached to the frame 220 or to the lower stabilizing member 624. The soil condition sensing assembly 760 would be attached to the lower stabilizing member 624.

In another embodiment, the stabilizing members 620 can be unnecessary and the actuator 730 connects directly from the frame 220 to the furrow opener 510.

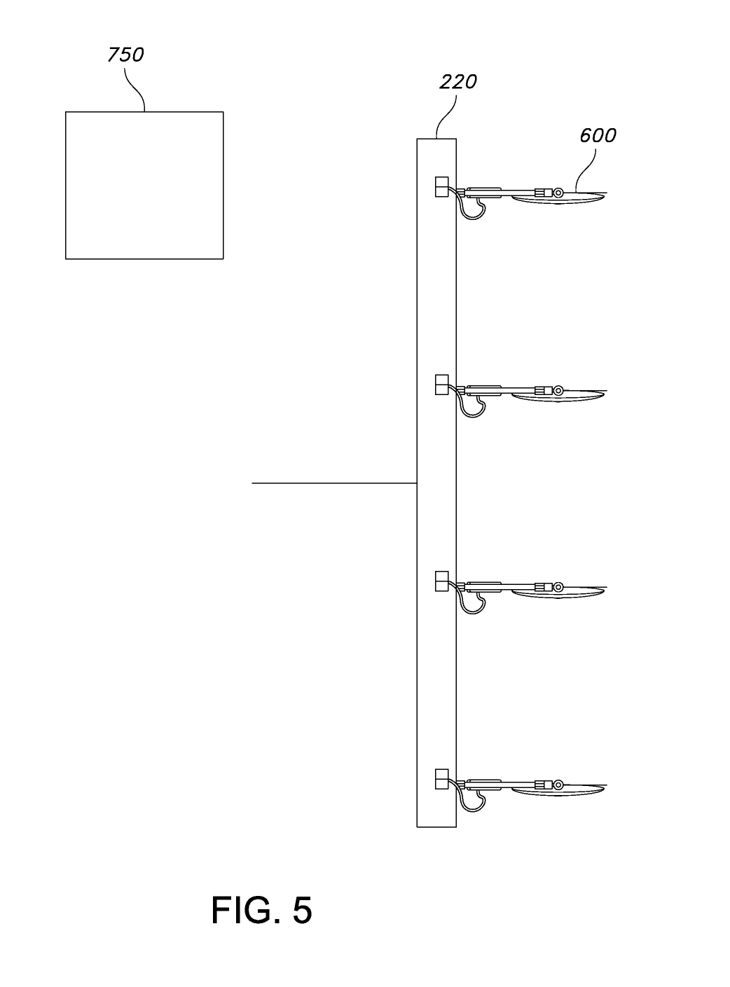

In another embodiment of FIG. 4, one processor 750 for each of the row units 600 on the frame 220 can be unnecessary. Instead, as in FIG. 5, one processor 750 can be located anywhere because the processor 750 wirelessly sends and receives information between itself and the row unit 600.

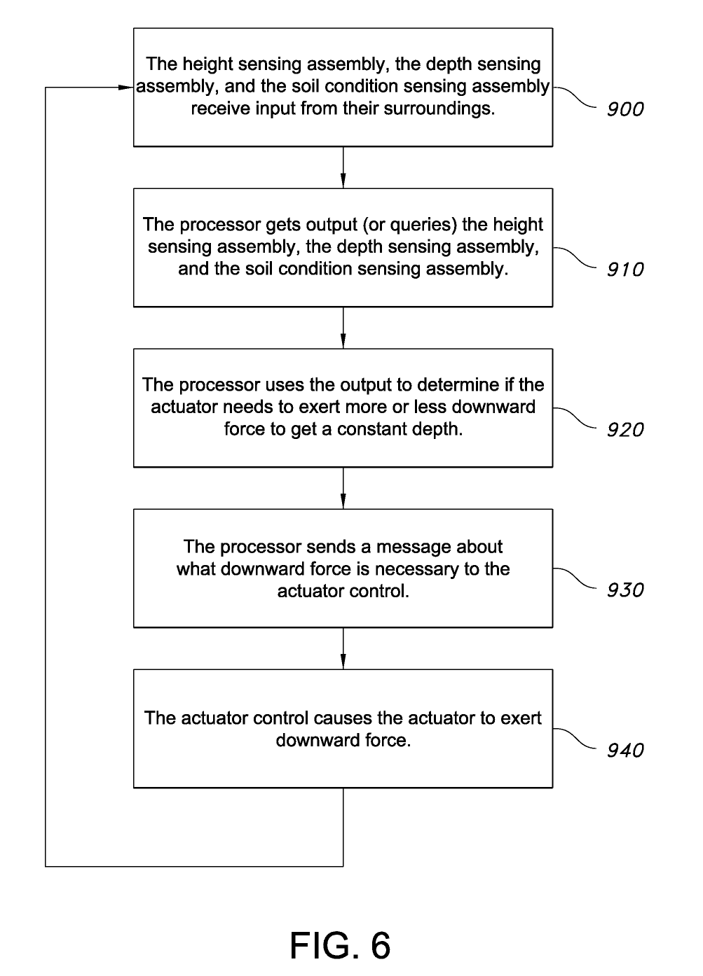

In FIG. 6, in box 900 the height sensing assembly 710; the depth sensing assembly 720; and the soil condition sensing assembly 760 receive input from their surroundings. In box 910, the processor 750 gets output from (or queries) the height sensing assembly 710; the depth sensing assembly 720; and the soil condition sensing assembly 760. Next, in box 920 the processor 750 determines if the actuator 730 needs to exert more or less downward force to get a constant depth. In box 930, the processor 750 sends a message about what downward force is necessary to the actuator control 740. In box 940, the actuator control 740 causes the actuator 730 to exert downward force. Then, the process starts again at box 900.

1.-20. (canceled)

21. A method for providing depth control, the method comprising:
receiving height data;
receiving soil condition data;
calculating a proper depth based upon the height data and the soil condition data;
receiving depth data from a depth sensing assembly, the depth data comprising an actual depth of a furrow opener;
comparing the received actual depth to the calculated proper depth; and
sending information to an actuator control, the information based on the comparison of the received actual depth to the calculated proper depth.

22. The method of claim 21, wherein receiving the height data comprises receiving the height data from a height sensing assembly.

23. The method of claim 21, wherein receiving the height data comprises receiving the height data from a height sensing assembly wherein the height sensing assembly does not contact soil.

24. The method of claim 21, wherein receiving the soil condition data comprises receiving the soil condition data from a soil condition sensing assembly.

25. The method of claim 21, wherein receiving the soil condition data comprises receiving the soil condition data comprising information regarding the effect of current ground speed of the furrow opener.

26. The method of claim 21, wherein receiving the soil condition data comprises receiving the soil condition data comprising density of soil the furrow opener is in contact with.

27. The method of claim 21, wherein receiving the soil condition data comprises receiving the soil condition data comprising compaction of soil the furrow opener is in contact with.

28. The method of claim 21, wherein receiving the depth data comprises receiving the depth data from a depth sensing assembly.

29. The method of claim 21, wherein receiving the depth data from the depth sensing assembly, the depth data comprising the actual depth of the furrow opener comprises receiving the depth data from the depth sensing assembly, the depth data comprising the actual depth of the furrow opener comprising one of the following: a disc, a knife, a sweep, a double disc, and a single angle disc.

30. The method of claim 21, wherein sending the information to the actuator control comprises sending the information configured to cause the actuator control to adjust a down force exerted by an actuator.

31. The method of claim 21, wherein sending the information to the actuator control comprises sending the information configured to cause the actuator control to adjust a down force exerted by an actuator to cause the actual depth of the furrow opener to be within +/−10% of the proper depth.

32. The method of claim 21, further comprising receiving the information at the actuator control.

33. The method of claim 21, further comprising:
receiving the information at the actuator control; and
adjusting, by the actuator control based on the received information, a down force exerted by an actuator.

34. The method of claim 21, further comprising:
receiving the information at the actuator control; and
adjusting, by the actuator control based on the received information, a down force exerted by an actuator to cause the actual depth of the furrow opener to be within +/−10% of the proper depth.

35. A system for providing depth control, the system comprising:
a memory storage; and
a processing unit coupled to the memory storage, wherein the processing unit is operative to:
receive height data from a height sensing assembly;
receive soil condition data from a soil condition sensing assembly;
calculate a proper depth based upon the height data and the soil condition data;
receive depth data from a depth sensing assembly, the depth data comprising an actual depth of a furrow opener;
compare the received actual depth to the calculated proper depth; and
send information to an actuator control, the information based on the comparison of the received actual depth to the calculated proper depth, the information configured to cause the actuator control to adjust a down force exerted by an actuator to cause the actual depth of the furrow opener to be within +/−10% of the proper depth.

36. The system of claim 35, wherein the height sensing assembly does not contact soil.

37. The system of claim 35, wherein soil condition data comprises information regarding the effect of current ground speed of the furrow opener, density of soil the furrow opener is in contact with, and compaction of the soil the furrow opener is in contact with.

38. A system for providing depth control, the system comprising:
a memory storage; and
a processing unit coupled to the memory storage, wherein the processing unit is operative to:
receive a plurality of height data from a respective plurality of height sensing assemblies, each one of the plurality of height sensing assemblies corresponding to respective ones of a plurality of furrow openers;
receive a plurality of soil condition data from a respective plurality of soil condition sensing assemblies, each one of the plurality of soil condition sensing assemblies corresponding to respective ones of the plurality of furrow openers;
calculate a plurality of proper depths respectively corresponding to each of the plurality of furrow openers based upon the respective plurality of height data and the respective plurality of soil condition data;
receive a plurality of depth data respectively from a plurality of depth sensing assemblies, the plurality of depth data comprising a plurality of actual depths respectively corresponding to the plurality of furrow openers;
compare the received plurality of actual depth to the calculated plurality of proper depth respectively; and
send a plurality of information to a respective plurality of actuator controls, the plurality of information based on the comparison of the received plurality of actual depth to the calculated plurality of proper depth respectively, the plurality of information configured to cause each of the plurality of actuator controls to adjust each of a plurality of respective down forces exerted by a respective plurality of actuators to cause the actual depth of each of the respective plurality of furrow openers to be within +/−10% of the plurality of respective proper depths.

39. The system of claim 38, wherein none of the plurality of height sensing assemblies contact soil.

40. The system of claim 38, wherein the plurality of soil condition data comprise information regarding the effect of current ground speed of the respective plurality of furrow openers, density of soil the respective plurality of furrow openers are in contact with, and compaction of the soil the respective plurality of furrow openers are in contact with.
